(19) United States
(12) Patent Application Publication
(10) Pub. No.: US 2010/0270048 A1
(43) Pub. Date: Oct. 28, 2010

(54) REACTION ADAPTORS FOR TORQUE POWER TOOLS AND METHODS OF USING THE SAME

(76) Inventor: John K. Junkers, Saddle River, NJ (US)

Correspondence Address: Justin B. Bender, Esq., 445 Park Avenue, 9th Floor, New York, NY, 10022, US

(21) Appl. No.: 12/428,200

(22) Filed: Apr. 22, 2009

(51) Int. Cl. B25B 21/00; B25B 23/00

(52) U.S. Cl. 173/176; 173/171

(57) ABSTRACT

Reaction adaptors for torque power tools pneumatically, electrically, hydraulically and manually driven, tools having the adaptors, and methods of using the same, are disclosed. In one illustrative example, a reaction adaptor includes a first force-transmitting element, when engaged with a tool, being rotatable about a turning force axis of the tool; and a second force-transmitting element, when engaged with the first element, being one of rotatable about, extensible and retractable along, and rotatable about and extensible and retractable along at least a distal portion of the first element. In another illustrative example, a tool for tightening or loosening a fastener includes the reaction adaptor.

A method of using the tool having the reaction adaptor includes the acts of providing the tool; and providing the reaction adaptor. The act of providing the reaction adaptor includes the acts of engaging, with the tool, a first force-transmitting element being rotatable about a turning force axis of the tool; and engaging, with the first element, a second force-transmitting element being one of rotatable about, extensible and retractable along, and rotatable about and extensible and retractable along at least a distal portion of the first element.

### BACKGROUND

1. Field of the Technology

The present application relates generally to torque power tools, and more particularly to reaction adaptors for tools, tools having adaptors, and methods of using the same.

2. Description of the Related Art

Torque power tools are known in the art and include those driven pneumatically, electrically, hydraulically, manually, by a torque multiplier, or otherwise powered. All torque power tools have a turning force and an equal and opposite reaction force. Often this requires the use of reaction fixtures to abut against viable and accessible stationary objects to stop the housing of the tool from turning backward, while a fastener, such as for example a nut, turns forward. The stationary object must be viable in that it must be able to absorb the reaction force and be accessible in that it must be nearby for the reaction fixture to abut against it. The reaction fixture may be connected around an axis or the housing, and a mechanism is provided to hold the fixture steady relative to the tool housing during operation. This may be achieved with splines, polygons, or other configurations. Several examples of known torque power tools that include a reaction arm to abut against a stationary object are disclosed in U.S. Pat. No. 6,152,243, U.S. Pat. No. 6,253,642 and U.S. Pat. No. 6,715,881, commonly owned and incorporated by reference herein.

Present reaction fixtures limit tool functionality. Those connected about a turning force axis, on the one hand, allow for complete rotation of a tool housing about the turning force axis without changing the abutment point. On the other hand, they are limited to coaxial abutment against stationary objects. Those connected at the housing, on the one hand, allow for abutment against stationary objects positioned in various circumferential and spatial locations relative to the nut to be turned. On the other hand, they prevent complete rotation of the tool housing about the turning force axis without changing the abutment point.

Adjustability of resent reaction fixtures is limited to about a single axis which precludes the use of a single tool in assemblies having viable stationary objects in non-accessible locations. Operators commonly need several tools at a workstation each having a reaction fixture oriented differently to abut against a viable and accessible stationary object. Alternatively, operators must disassemble the tool, reposition the reaction fixture and reassemble the tool. The former solution is expensive while the latter solution is time consuming.

If present reaction fixtures cannot abut against viable and accessible stationary objects properly, custom reaction fixtures need to be engineered. Re-engineering of the tool connection means to accommodate custom reaction fixtures is prohibitively expensive, unsafe and time consuming. Tool manufacturers offer several commercially available reaction fixture constructions for these reasons.

During operation of tools, twisting forces are induced on the housing along the turning force axis by the transfer of the reaction force through the reaction fixture to the stationary object. The reaction force for tools with torque output of 10,000 ft.lbs. can be as high as 40,000 lbs. and is applied as a side load to the stationary object in one direction and to the fastener to be turned in an opposite direction. Large reaction forces bend and increase the turning friction of the fastener.

Twisting forces are limited and least destructive when the reaction force is transferred to a stationary object perpendicular to the turning force axis. The ideal abutment point is perpendicular to the turning force axis and on the same plane as the fastener to be turned. Tools operating with sockets that reach down to the same plane as the fastener cause twisting forces. Twisting forces exacerbate fastener-bending forces roughly by a distance H between the attachment point of the socket to the tool and the fastener plane. These twisting and fastener-bending forces are limited and least destructive when the reaction force is transferred perpendicular to the turning force axis in a plane roughly the distance H above the fastener plane. Thus the ideal abutment pressure point is perpendicular to the turning force axis in the plane distance H above the fastener plane. Rarely do present reaction fixtures transfer the reaction force to the ideal abutment pressure point. Reaction fixtures must be adjustable to minimize twisting and fastener-bending forces so as to avoid the tool from jumping off of the job or from failing.

Present reaction fixtures are not adjustable around multiple axes due to concerns regarding total tool weight. Tools need to be portable for the majority of fasteners. The maximum tool weight to be carried safely by an operator should not exceed 30 lbs. For larger fasteners, the maximum tool weight to be carried safely by two operators should not exceed 60 lbs. For applications where the only viable and accessible stationary object requires custom reaction fixtures, these weights are exceeded and crane use is required. Crane use to support the tool is expensive and is economical only for large fasteners.

Other tools provided with reaction fixtures of the prior art are disclosed, for example, in U.S. Pat. Nos. 3,361,218, 4,549,438, 4,538,484, 4,607,546, 4,619,160, 4,671,142, 4,706,526, 4,928,558, 5,027,932, 5,016,502, 5,142,951, 5,152,200, 5,301,574, 5,791,619, 6,260,443.

Accordingly, what are needed are reaction force transfer mechanisms which overcome the deficiencies of the prior art, as well as methods of using the same.

### SUMMARY

Reaction adaptors for torque power tools pneumatically, electrically, hydraulically and manually driven, tools having the adaptors, and methods of using the same, are disclosed. In one illustrative example, a reaction adaptor includes a first force-transmitting element, when engaged with a tool, being rotatable about a turning force axis of the tool; and a second force-transmitting element, when engaged with the first element, being one of rotatable about, extensible and retractable along, and rotatable about and extensible and retractable along at least a distal portion of the first element. In another illustrative example, a tool for tightening or loosening a fastener includes the reaction adaptor.

A method of using the tool having the reaction adaptor includes the acts of providing the tool; and providing the reaction adaptor. The act of providing the reaction adaptor includes the acts of engaging, with the tool, a first force-transmitting element being rotatable about a turning force axis of the tool; and engaging, with the first element, a second force-transmitting element being one of rotatable about, extensible and retractable along, and rotatable about and extensible and retractable along at least a distal portion of the first element.

Advantageously, the first element is engageable and attachable separately, individually and independently to the tool and the second element is engageable and attachable separately, individually and independently to the first element. Portability of the tool is maximized while weight of the tool is minimized. Commercially available reaction fixtures may be used with or in replacement of portions of first and second elements, rather than custom reaction fixtures, thereby reducing costs and increasing safety. The reaction adaptor is adjustable to minimize twisting and fastener-bending forces so as to avoid the tool from jumping off of the job or from failing. The reaction adaptor, when engaged with the tool, is adjustable to abut against viable and otherwise inaccessible stationary objects at the ideal abutment pressure point. The reaction adaptor, when attached to the tool, transfers the turning force to at the ideal abutment pressure point during operation. Operators no longer need several tools at the workstation each having a reaction fixture oriented differently to abut against viable stationary objects for each application. Nor do operators need to completely disassemble the tool, reposition the reaction adaptor and reassemble tool for each application. Also, the reaction adaptor allows for complete rotation of the tool housing about the turning force axis without changing the abutment point thereby avoiding any circumferential obstructions in a rotation plane of the housing.

### BRIEF DESCRIPTION OF THE DRAWINGS

For a fuller understanding of the nature and advantages of the present application, as well as the preferred mode of use, reference should be made to the following detailed description read in conjunction with the accompanying drawings:

FIG. 1 is a side view of an exemplary embodiment of a reaction adaptor for a torque power tool and the tool having the reaction adaptor of the present application;

FIG. 2 is a plan view FIG. 1;

FIG. 3 is a three-dimensional view of FIG. 1 having the reaction adaptor adjusted to abut against a stationary object about a pipe flange;

FIG. 4 is a flowchart which describes an exemplary method of using the reaction adaptor and the tool having the reaction adaptor;

FIGS. 5A-5C are perspective views of alternative embodiments of a third and a fourth connecting means of a first and a second force-transmitting element and a fourth connecting means of a second force-transmitting element of the reaction adaptor including bores and threaded nuts, bores and detents, and polygonal configurations;

FIG. 6 is a display of commercially available reaction fixtures usable with portions of the reaction adaptor;

FIG. 7 is a three-dimensional view of the tool, a first torque power tool attached by an alternative embodiment of the reaction adaptor;

FIG. 8 is a side view of the tool having the reaction adaptor, a first reaction adaptor, attached about the turning force axis and a second reaction adaptor, attached about the piston axis; and

FIG. 9 is a three-dimensional view of a first one of pneumatically, electrically, hydraulically and manually driven torque power tool and a second one of pneumatically, electrically, hydraulically and manually driven torque power tool attached by the reaction adaptor of FIG. 7.

### DETAILED DESCRIPTION OF THE PREFERRED EMBODIMENTS

Reaction adaptors for torque power tools pneumatically, electrically, hydraulically and manually driven, tools having the adaptors, and methods of using the same, are disclosed. In one illustrative example, a reaction adaptor includes a first force-transmitting element, when engaged with a tool, being rotatable about a turning force axis of the tool; and a second force-transmitting element, when engaged with the first element, being one of rotatable about, extensible and retractable along, and rotatable about and extensible and retractable along at least a distal portion of the first element. In another illustrative example, a tool for tightening or loosening a fastener includes the reaction adaptor.

A method of using the tool having the reaction adaptor includes the acts of providing the tool; and providing the reaction adaptor. The act of providing the reaction adaptor includes the acts of engaging, with the tool, a first force-transmitting element being rotatable about a turning force axis of the tool; and engaging, with the first element, a second force-transmitting element being one of rotatable about, extensible and retractable along, and rotatable about and extensible and retractable along at least a distal portion of the first element.

Advantageously, the first element is engageable and attachable separately, individually and independently to the tool and the second element is engageable and attachable separately, individually and independently to the first element. Portability of the tool is maximized while weight of the tool is minimized. Commercially available reaction fixtures may be used with or in replacement of portions of first and second elements, rather than custom reaction fixtures, thereby reducing costs and increasing safety. The reaction adaptor is adjustable to minimize twisting and fastener-bending forces so as to avoid the tool from jumping off of the job or from failing. The reaction adaptor, when engaged with the tool, is adjustable to abut against viable and otherwise inaccessible stationary objects at the ideal abutment pressure point. The reaction adaptor, when attached to the tool, transfers the turning force to at the ideal abutment pressure point during operation. Operators no longer need several tools at the workstation each having a reaction fixture oriented differently to abut against viable stationary objects for each application. Nor do operators need to completely disassemble the tool, reposition the reaction adaptor and reassemble tool for each application. Also, the reaction adaptor allows for complete rotation of the tool housing about the turning force axis without changing the abutment point thereby avoiding any circumferential obstructions in a rotation plane of the housing.

The following description incorporates the best embodiment presently contemplated for carrying out the present application. This description is made for the purpose of illustrating the general principles of the present application and is not meant to limit the inventive concepts claimed herein.

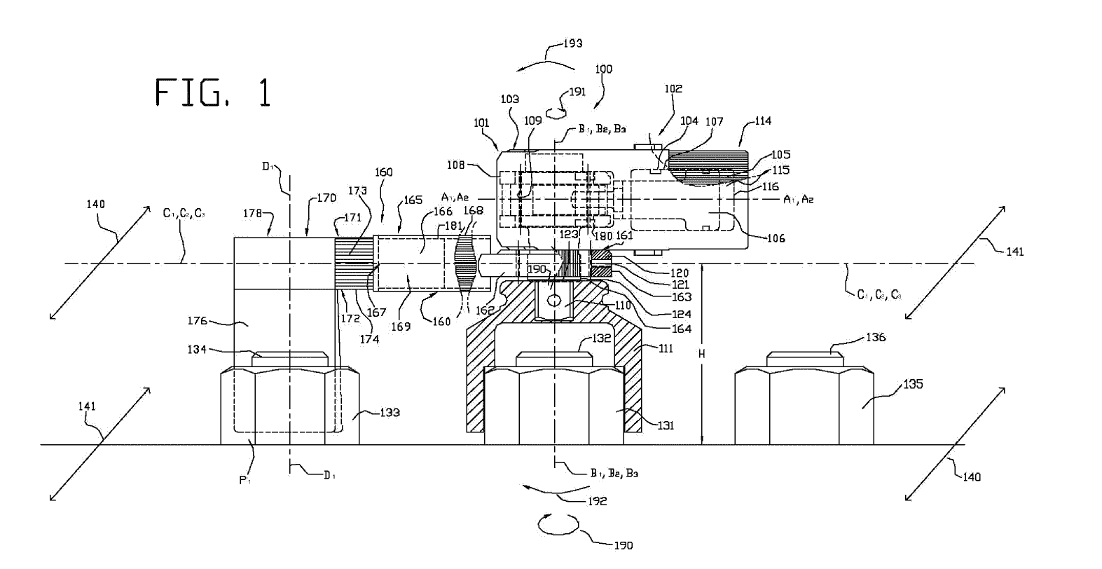

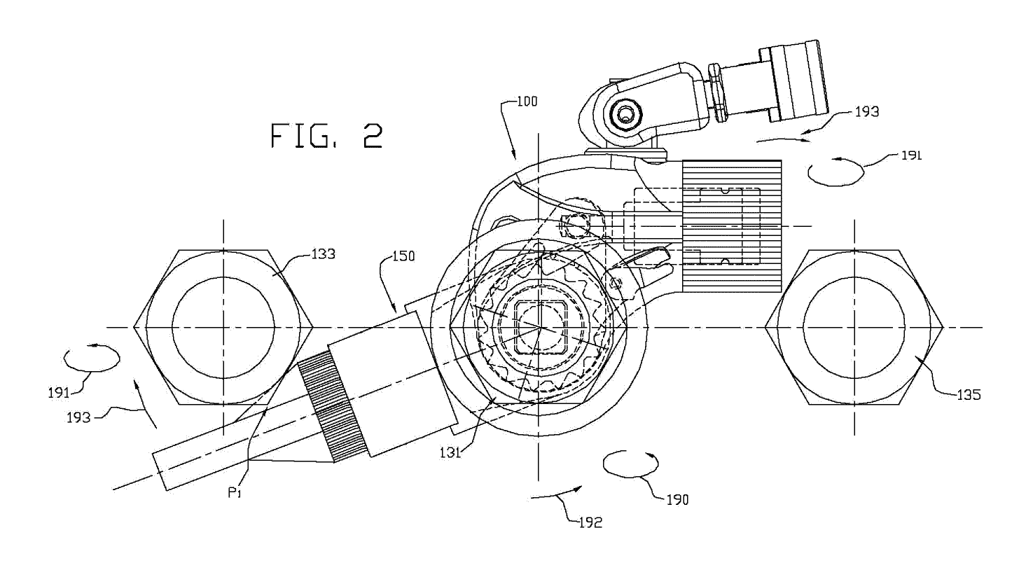

An Exemplary Embodiment of a Reaction Adaptor for a Torque Power Tool and the Tool Having the Reaction Adaptor. FIG. 1 shows a side view of an exemplary embodiment of a reaction adaptor 150 for a torque power tool 100. FIG. 2 is a plan view of FIG. 1. Tool 100 includes a housing 101 having two housing portions, a cylinder portion 102 and a driving portion 103.

Cylinder-piston means 104 are arranged in cylinder portion 102 and include a cylinder 105, a piston 106 reciprocatingly movable in cylinder 105 along a piston axis A₁, and a piston rod 107 connected with piston 106. A known lever-type ratchet mechanism 108 is arranged in driving portion 103, connected to and drivable by cylinder-piston means 104, and includes a ratchet 109. Ratchet 109 is turnable about a turning force axis B₁ which is perpendicular to piston axis A₁. Ratchet 109 is connected with a driving element 110 which receives a first turning force 190 acting about turning force axis B₁ in one direction 192 during operation of tool 100 (see also FIG. 2). Turning force 190 turns a hex socket 111 attached to driving element 110 which turns a nut 131.

A reaction support portion 114, formed on a part of cylinder portion 103 receives second turning force 191 acting about turning force axis B₁ in another direction 193 during operation of tool 100. Reaction support portion 114 is formed of an annular polygonal body 115 having a plurality of outer splines 116. Outer splines 116 are positioned circumferentially around annular body 115 and extend radially outwardly from a central axis A₂ which is coaxial with piston axis A₁.

A reaction support portion 120, connected to driving portion 103, also receives second turning force 191 acting about turning force axis B₁ in another direction 193 during operation of tool 100. Reaction support portion 120 is formed of an annular polygonal body 121 having a plurality of outer splines 123. Outer splines 123 are positioned circumferentially around annular body 121 and extend radially outwardly from a central axis B₂ which is coaxial with turning force axis B₁.

Reaction adaptor 150, when attached to reaction support portion 120, receives second turning force 191 acting in another direction 193 during operation. First and second turning forces 190 and 191 are equal to and in opposite directions to each other. First turning force 190 turns fastener 131 while reaction adaptor 150 transfers second turning force 191 to a stationary object at abutment pressure point P₁, in this case, a neighboring nut 133.

Reaction adaptor 150 generally includes a first force-transmitting element 160, when engaged with tool 100, being rotatable about turning force axis B₁; and a second force-transmitting element 170, when engaged with first element 160, being one of rotatable about, extensible and retractable along, and rotatable about and extensible and retractable along at least a distal portion 165 of first element 160. First element 160 includes a proximal portion 161 formed of an annular polygonal body 162 having a plurality of inner splines 163, and distal portion 165 formed of a tubular member 166 having an internal bore 167 with a plurality of inner splines 168. Second element 170 includes a proximal portion 171 formed of a tubular member 172 having a plurality of outer splines 173, and a distal portion 175 formed of a rectangular body 176. First element 160, when attached to tool 100, extends substantially perpendicular to and has a first force-transmitting axis C₁ substantially perpendicular to turning force axis B₁. Second element 170, when attached to first element 160, extends substantially perpendicular to and has a second force-transmitting axis D₁ substantially perpendicular to first force-transmitting axis C₁.

First element 160 is shown non-rotatably attached to reaction support portion 120 in a first position and held in place by a locking mechanism 180. First element 160 is engageable and attachable separately, individually, and independently to tool 100. Inner splines 163 are positioned circumferentially around the inside of annular body 162 and extend radially inwardly toward a central axis B₃. Annular body 162 is of such inner width and annular body 121 is of such outer width that inner splines 163 mesh with outer splines 123. Annular body 121 and proximal portion 161 include first and second connecting means 124 and 164. Reaction support portion 120 and first element 160 are attachable to each other by attaching first and second connecting means 124 and 164. Locking mechanism 180 may include a bore and pin or other well known configuration like a spring loaded reaction clamp at the base of reaction support portion 120 and receiving grooves on proximal portion 161. Axes B₁, B₂, and B₃ are coaxial when first element 160 and reaction support portion 120 are attached to each other and to tool 100.

Second element 170 is shown non-rotatably attached to first element 160 in a second position and held in place by a locking mechanism 181. Second element 170 is engageable and attachable separately, individually, and independently to first element 160. Inner splines 168 are positioned circumferentially around the inside of internal bore 167 and extend radially inwardly toward a central axis C₂. Outer splines 173 are positioned circumferentially around tubular member 172 and extend radially outwardly from a central axis C₃. Internal bore 167 is of such inner width and tubular member 172 is of such outer width that inner splines 168 mesh with outer splines 173. Internal bore 167 receives tubular member 172 in a telescoping arrangement. Distal portion 165 includes third connecting means 169 which comprises tubular member 166, internal bore 167, and inner splines 168. Proximal portion 171 includes fourth connecting means 174 which comprises tubular member 172 and outer splines 173. First and second elements 160 and 170 are attachable to each other by attaching third and fourth connecting means 169 and 174 which are held in place by locking mechanism 181. Locking mechanism 181 may include a bore and pin or other well known configuration like a spring loaded reaction clamp on distal portion 165 and receiving grooves on proximal portion 171. Axes B₁, B₂, and B₃ are coaxial and C₁, C₂, and C₃ are coaxial when second element 170, first element 160 and reaction support portion 120 are attached to each other and to tool 100. Rectangular body 176 of distal portion 175 as shown extends substantially perpendicular to tubular member 172 and first element 160.

Tool 100 is prepared to turn nut 131 threaded on a lug 132 to connect flanges (not shown). Reaction adaptor 150 is attached to tool 100 in a reaction force transfer position to transfer turning force 191, the reaction force, to nut 133 at abutment pressure point P₁ during operation. As turning force 190 turns hex socket 111 on nut 131, rectangular body 176, supported by distal portion 175, bears against abutment pressure point P₁ on the walls of nut 133. This prevents ratchet 109 from rotating inwardly relative to nut 131. Thus nut 131 is turned by hex socket 111 to a desired torque.

Nut 31 to be turned is located in the center, abutment pressure point P₁ for reaction adaptor 150 is arranged left of center, and nut 135 is arranged right of center. Since action and reaction are equal but opposite, reaction adaptor 150 pushes its abutment area backwards from the center (see FIG. 2). Side loads applied to driving portion 103 are reduced but not eliminated.

In an alternative mode of operation of the current embodiment, reaction adaptor 150 may transfer turning force 191 from reaction support portion 120 to turn nut 133. This is achieved by changing the abutment pressure point P₁ on the walls of nut 133. As ratchet 109 applies turning force 190 to nut 131, reaction adaptor 150 transfers turning force 191 from reaction support portion 120 to turn nut 133.

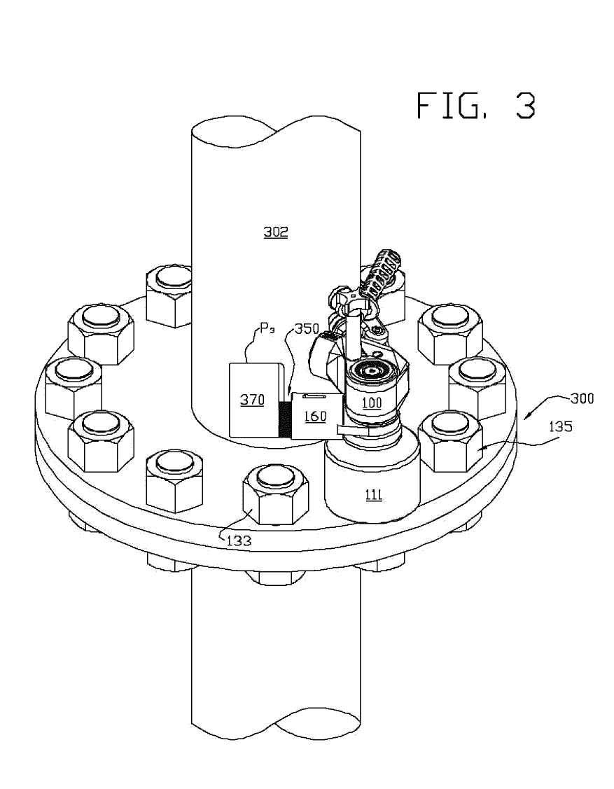

FIG. 3 is a three-dimensional view of FIG. 1 having a reaction adaptor 350 abutted against a piping segment 302 of a pipe flange 300. Reaction adaptor 350 is similar to reaction adaptor 150 of FIGS. 1-2 in all material ways except that second element 370 has been rotated counterclockwise to abut against piping segment 302 at an abutment pressure point P₃. As discussed previously, tool 100 operates with hex socket 111 which reaches down to a fastener plane 141. Twisting forces exacerbate fastener-bending forces by a distance H roughly between the attachment point of socket 111 to tool 100 at plane 140 and fastener plane 141 (see FIG. 1). In this embodiment, axes C₁, C₂, C₃ and D₁ lie in plane 140 at distance H above plane 141. The twisting and fastener-bending forces are limited and least destructive when turning force 191, the reaction force, is transferred perpendicular to turning force axis B₁ in plane 140. Thus the ideal abutment pressure point P₃ for reaction adaptor 350 is perpendicular to turning force axis B₁ in plane 140.

Advantageously, first element 160 is engageable and attachable separately, individually and independently to tool 100 and second element 170 is engageable and attachable separately, individually and independently to first element 160. The portability of tool 100 is maximized while the weight of tool 100 is minimized. Commercially available reaction fixtures may be used with or in replacement of portions of first and second elements 160 and/or 170, rather than custom reaction fixtures, thereby reducing costs and increasing safety. Reaction adaptor 150 is adjustable to minimize twisting and fastener-bending forces so as to avoid tool 100 from jumping off of the job or from failing. Reaction adaptor 150, when engaged with tool 100, is adjustable to abut against viable and otherwise inaccessible stationary objects at the ideal abutment pressure point P₃. Reaction adaptor 150, when attached to tool 100, transfers turning force 191 to at the ideal abutment pressure point P₃ during operation. Operators no longer need several tools at the workstation each having a reaction fixture oriented differently to abut against viable stationary objects for each application. Nor do operators need to completely disassemble tool 100, reposition reaction adaptor 150 and reassemble tool 100 for each application. Also, reaction adaptor 150 allows for complete rotation of housing 101 about turning force axis B₁ without changing abutment point P₃ thereby avoiding any circumferential obstructions in a rotation plane of housing 101.

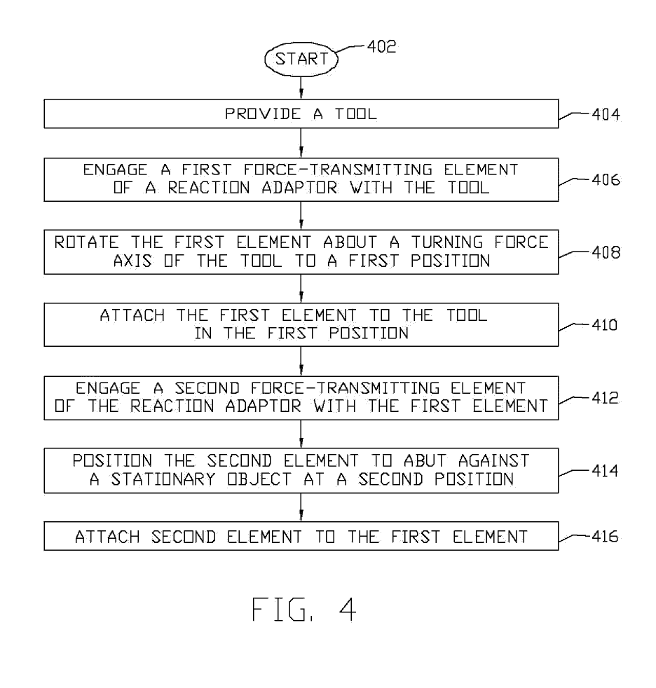

An Exemplary Method of Using the Reaction Adaptor and the Tool Having the Reaction Adaptor. FIG. 4 is a flowchart which describes an exemplary method of using the reaction adaptor and the tool having the reaction adaptor FIGS. 1-3 will be referenced with the flowchart steps of FIG. 4.

Beginning with step 404 of FIG.4, tool 100 is provided by providing housing 101 having cylinder portion 102 and driving portion 103; arranging, in cylinder portion 102, cylinder-piston means 104 movable along piston axis A₁; arranging, in driving portion 103, ratchet mechanism 108 connected to and drivable by cylinder-piston means 104; providing, in ratchet mechanism 108, ratchet 109 turnable about turning force axis B which is perpendicular to piston axis A₁; and providing driving element 110, connected to ratchet 109, receiving first turning force 190 acting about turning force axis B₁ in one direction 192 during operation of tool 100.

Next, in step 406 of FIG. 4, first element 160 is engaged with tool 100 by bringing proximal portion 161 substantially adjacent to reaction support portion 120 and substantially aligning axes B₁, B₂, and B₃. Annular body 162 is passed over driving element 110.

In step 408 of FIG. 4, first element 160 is rotated about turning force axis B₁ to a first position. The first position is chosen based on the proximity of a viable and accessible stationary object that may be found in various circumferential and spatial locations relative to nut 131. First element 160, when engaged with tool 100, is rotatable about turning force axis B₁ because inner splines 163 and outer splines 123 have not yet been meshed.

In step 410 of FIG. 4, first element 160 is attached to reaction support portion 120 in the first position by meshing inner splines 163 and outer splines 123 and activating locking mechanism 180. In steps not shown in FIG. 4, hex socket 111 is attached to driving element 110, and tool 100 is placed on nut 131.

In step 412 of FIG. 4, second element 170 is engaged with first element 160 by bringing proximal portion 171 substantially adjacent to distal portion 165 and substantially aligning axes C₁, C₂, and C₃.

In step 414 of FIG. 4, second element 170 is positioned to abut against the stationary object in a second position by rotating it about and then retracting it along distal portion 165. The second position is chosen based on the proximity of the viable and accessible stationary object. Second element 170, when engaged with first element 160, is rotatable about distal portion 165 because inner splines 168 have not yet been meshed with outer splines 173. Second element 170 is rotated about distal portion 165 to one of a plurality of extension angles; inner splines 168 and outer splines 173 are meshed when internal bore 167 receives tubular member 172 in a telescoping arrangement; and second element 170 is retracted along distal portion 165 to one of a plurality of extension lengths. Reaction adaptor 150, in the second position, abuts against the viable and accessible stationary object, nut 133. In step 416 of FIG. 4, second element 170 is attached to first element 160 in the second position by activating locking mechanism 181. Reaction adaptor 150 is now in reaction force transfer position.

When necessary to disassemble tool 100 or adjust reaction adaptor 150 to another abutment pressure point, second element 170 is detached from first element 160 by deactivating locking mechanism 181. Second element 170 is extended along distal portion 165 until inner splines 168 and outer splines 173 are no longer meshed and second element 170 is no longer substantially adjacent first element 160. Tool 100 may be displaced from nut 131 and hex socket 111 may be detached from driving element 110. First element 160 is detached from reaction support portion 120 by deactivating locking mechanism 180, unmeshing inner splines 163 and outer splines 123, and removing it from reaction support portion 120. The steps of FIG. 4 are then repeated.

In an alternative method of using the reaction adaptor and the tool having the reaction adaptor, the second element is engaged with the first element prior to the first element being engaged with the tool. The reaction adaptor is fully assembled and pre-adjusted and may be abutted against a viable and accessible stationary object prior to being engaged with the tool.

Alternative Structures of the First and Second Connecting Means. Reaction support portion 120 may have a height such that first element 160, when engaged with reaction support portion 120, is also slidable along reaction support portion 120. Distance H and thus plane 140 may be varied by sliding first element 160 along reaction support portion 120.

Proximal portion 161 may have a hinged annular body 162 such that annular body 162 is not passed over driving element 10 in step 406 of FIG. 4. First element 160 is engaged with tool 100 by bringing proximal portion 161 substantially adjacent to reaction support portion 120, unhinging annular body 162, and substantially aligning axes B₁, B₂, and B₃. Note that a similar structure may be used for other tool and reaction adaptor components.

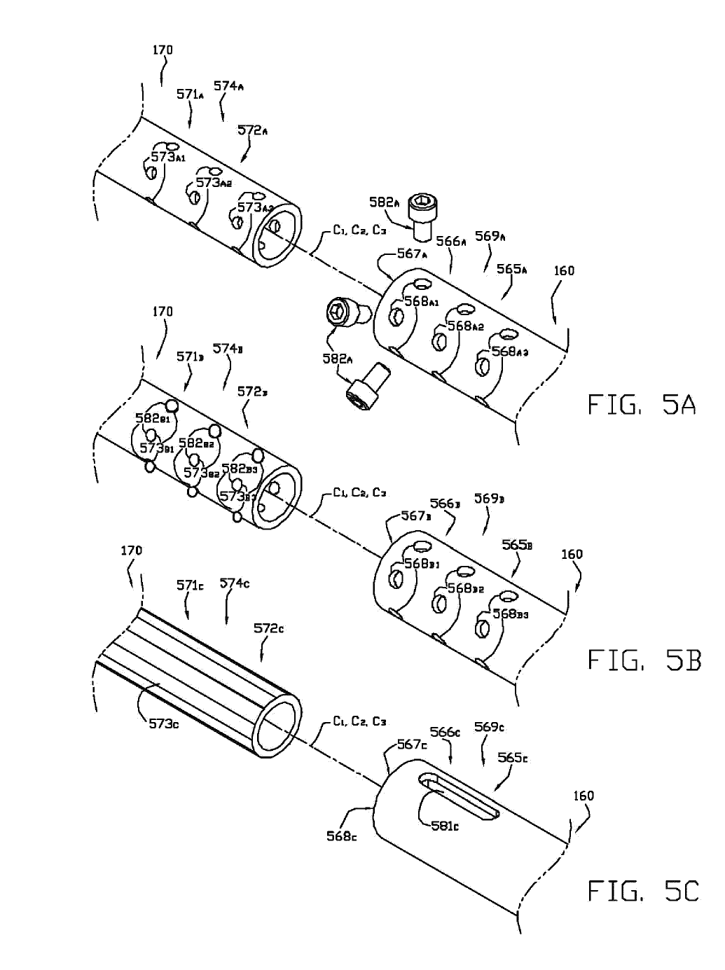

Alternative Structures of the Third and Fourth Connecting Means. FIGS. 5A-5C are perspective views of alternative structures of the third and fourth connecting means of the first and second elements including bores and threaded nuts, bores and detents, and polygonal configurations. Referring back to FIGS. 1-4, distal portion 165 and proximal portion 171 include third and fourth connecting means 169 and 174 which are splined configurations. First and second elements 160 and 170 are attachable to each other by attaching third and fourth connecting means 169 and 174.

FIG. 5A is a perspective view of a second structure of a third and fourth connecting means 569_{A} and 574_{A}. Generally discussion related to FIGS. 1-3 applies to FIG. 5A. A portion of distal portion 565_{A} of first element 160 is shown formed of a tubular member 566_{A} having an internal bore 567_{A} and at least three sets of a plurality of radially directed, circumferentially spaced, threaded-through bores 568_{A1}, 568_{A2}, and 568_{A3}. A portion of proximal portion 571_{A} of second element 170 is shown formed of a tubular member 572_{A} having at least three sets of a plurality of radially directed, circumferentially spaced, inwardly tapered attachment bores 573_{A1}, 573_{A2}, and 573_{A3}, so as to operatively engage with first element 160. Bore sets 568_{A1}-568_{A3}, are of such size as to receive a threaded end of threaded bolts 582 and bore sets 573_{A1}-573_{A3} are of such size so as to receive a tapered end of bolts 582_{A} at one of a plurality of extension angles and extension lengths. Internal bore 567_{A} is of such inner width and tubular member 572_{A} is of such outer width that bore sets 568_{A1}-568_{A3} align with bore sets 573_{A1}-573_{A3}. Internal bore 567_{A} receives tubular member 572_{A} in a telescoping arrangement. Distal portion 565_{A} includes third connecting means 569_{A} which comprises tubular member 566_{A}, internal bore 567_{A}, and bore sets 568_{A1}-568_{A3}. Proximal portion 571_{A} includes fourth connecting means 574_{A} which includes tubular member 572_{A} and bore sets 573_{A1}-573_{A3}. First and second elements 160 and 170 are attachable to each other by attaching third and fourth connecting means 569_{A} and 574_{A}.

Generally discussion related to the method of FIG. 4 applies to FIG. 5A. In step 412 of FIG. 4, second element 170 is engaged with first element 160 by bringing proximal portion 571_{A} substantially adjacent to distal portion 565_{A}, substantially aligning axes C₁, C₂, and C₃, and inserting proximal portion 571_{A} into distal portion 565_{A} in a telescoping arrangement.

In step 414 of FIG. 4, second element 170 is positioned to abut against the stationary object in a second position by rotating it about and extending and/or retracting it along distal portion 565_{A}, in no particular order. Second element 170, when engaged with first element 160, is rotatable about and extensible and retractable along distal portion 565_{A} because one of bore sets 568_{A1}-568_{A3} have not yet been attached to one of bore sets 573_{A1}-573_{A3} by bolts 582_{A2}. Second element 170 is rotated about distal portion 565_{A} to one of a plurality of extension angles so that the constituent bores of one of bore sets 568_{A1}-568_{A3}align with the constituent bores of one of bore sets 573_{A1}-573_{A3}; and second element 170 is extended and/or retracted along distal portion 565_{A} to one of a plurality of extension lengths so that one of bore sets 568_{A1}-568_{A3} align with one of bore sets 573_{A1}-573_{A3}. Distal portion 175 and thus reaction adaptor 150 abut against the viable and accessible stationary object, nut 133, in the second position.

In step 416 of FIG. 4, second element 170 is attached to first element 160 in the second position by tightening bolts 582_{A} in the aligned bores. Second element 170 is attached to first element 160 thus preventing further axial and radial displacement until bolts 582_{A} are loosened and removed.

FIG. 5B is a perspective view of a third structure of a third and fourth connecting means 569_{B} and 574_{B}. Generally discussion related to FIGS. 1-3 applies to FIG. 5B. A portion of distal portion 565_{B} of first element 160 is shown formed of a tubular member 566B having an internal bore 567B and at least three sets of a plurality of radially directed, circumferentially spaced bores 568_{B1}, 568_{B2}, and 568_{B3}. A portion of proximal portion 571_{B} of second element 170 is shown formed of a tubular member 572_{B} having at least three sets of a plurality of radially directed, circumferentially spaced bores 573_{B1}-573_{B3}. At least three sets of a plurality of detents 582_{B1}-582_{B3} project through bore sets 573_{B1}-573_{B3} and are biased radially outwardly by spring mechanisms (not shown) so as to operatively engage with first element 160. Bore sets 568_{B1}-568_{B3} are of such size as to receive detent sets 582_{B1}-582_{B3} at one of a plurality of extension angles and extension lengths. Internal bore 567_{B} is of such inner width and tubular member 572_{B} is of such outer width that bore sets 568_{B1}-568_{B3} align with bore sets 573_{B1}-573_{B3} Internal bore 567_{B} receives tubular member 572_{B} in a telescoping arrangement. Distal portion 565_{B} includes third connecting means 569_{B} which includes tubular member 566_{B}, internal bore 567_{B}, and bore sets 568_{B1}-568_{B3}. Proximal portion 571_{B} includes fourth connecting means 574_{B} which includes tubular member 572_{B}, bore sets 573_{B1}-573_{B3}, and detent sets 582_{B1}-582_{B3}. First and second elements 160 and 170 are attachable to each other by attaching third and fourth connecting means 569_{B} and 574_{B}.

Generally discussion related to the method of FIG. 4 applies to FIG. 5B. In step 412 of FIG. 4, second element 170 is engaged with first element 160 by bringing proximal portion 571_{B} substantially adjacent to distal portion 565_{B}, substantially aligning axes C₁, C₂, and C₃, and inserting proximal portion 571_{B} into distal portion 565_{B} in a telescoping arrangement.

In step 414 of FIG. 4, second element 170 is positioned to abut against the stationary object in a second position by extending and/or retracting it along and rotating it about distal portion 565_{B}, in no particular order. Second element 170, when engaged with first element 160, is rotatable about and extensible and retractable along distal portion 565_{B} because one of bore sets 568_{B1}-568_{B3} have not yet been attached to one of bore sets 573_{B1}-573_{B3} by detent sets 582_{B1}-582_{B3}. Second element 170 is extended and/or retracted along distal portion 565_{B} to one of a plurality of extension lengths so that one of bore sets 568_{B1}-568_{B3} align with one of bore sets 573_{B1}-573_{B3}; and second element 170 is rotated about distal portion 565_{B} to one of a plurality of extension angles so that the constituent bores of one of bore sets 568_{B1}-568_{B3} align with the constituent bores of one of bore sets 573_{B1}-573_{B3}. Distal portion 175 and thus reaction adaptor 150 abut against the viable and accessible stationary object, nut 133, in the second position.

In step 416 of FIG. 4, second element 170 is attached to first element 160 in the second position when at least one of spring biased detent sets 582_{B1}-582_{B3} fall into register with at least one of bore sets 568_{B1}-568_{B3}. At least one of spring biased detent sets 582_{B1}-582_{B3} will be pushed out through at least one of bore sets 568_{B1}-568_{B3}, thereby attaching second element 170 to first element 160 and preventing further axial and radial displacement until at least one of spring biased detent sets 582_{B1}-582_{B3} are squeezed radially inwardly to where the tips may slip past at least one of bore sets 568_{B1}-568_{B3}.

FIG. 5C is a perspective view of a fourth structure of a third and fourth connecting means 569_{C} and 574_{C}. Generally discussion related to FIGS. 1-3 applies to FIG. 5C. A portion of distal portion 565_{C} of first element 160 is shown formed of a tubular member 566_{C} having an internal bore 567_{C} with a polygonal inner wall 568_{C} (not shown). A portion of proximal portion 571_{C} of second element 170 is shown formed of a tubular member 572_{C} having a polygonal outer wall 573_{C}. Internal bore 567_{C} is of such inner width and tubular member 572_{C} is of such outer width that internal bore 567_{C} receives tubular member 572_{C} in a telescoping arrangement and polygonal inner wall 568_{C} meshes with polygonal outer wall 573_{C} at one of a plurality of extension angles and extension lengths. Distal portion 565_{C} includes third connecting means 569_{C} which includes tubular member 566_{C}, internal bore 567_{C}, and polygonal inner wall 568_{C}. Proximal portion 571_{C} includes fourth connecting means 574_{C} which includes tubular member 572_{C} and polygonal outer wall 573_{C}. First and second elements 160 and 170 are attachable to each other by attaching third and fourth connecting means 569_{C} and 574_{C}.

Generally discussion related to the method of FIG. 4 applies to FIG. 5C. In step 412 of FIG. 4, second element 170 is engaged with first element 160 by bringing proximal portion 571_{C} substantially adjacent to distal portion 565_{C} and substantially aligning axes C₁, C₂, and C₃.

In step 414 of FIG. 4, second element 170 is positioned to abut against the stationary object in a second position by rotating it about and then retracting it along distal portion 565_{C}. Second element 170, when engaged with first element 160, is rotatable about distal portion 565_{C} because inner wall 568_{C} has not yet been meshed with outer wall 573_{C}. Second element 170 is rotated about distal portion 565_{C} to one of a plurality of extension angles; inner wall 568_{C} and outer wall 573_{C} are meshed when internal bore 567_{c} receives tubular member 572_{C} in a telescoping arrangement; and second element 170 is retracted along distal portion 565_{C} to one of a plurality of extension lengths. Distal portion 575_{C} and thus reaction adaptor 150 abut against the viable and accessible stationary object, nut 133, in the second position. In step 416 of FIG. 4, second element 170 is attached to first element 160 in the second position by activating locking mechanism 581_{C}.

Note that other structures of the third and fourth connecting means may be used including a bores and pins and hinged body configuration.

Alternative Structures of Portions of the First and Second Elements. In the exemplary embodiment of FIGS. 1-3, at least portions of first and second elements 160 and 170 extend perpendicular to each other. Alternatively, at least distal portion 165 of first element 160, when attached to tool 100, may extend substantially at an angle of 45°-135° to turning force axis B₁. First force-transmitting axis C₁ would be of a similar angle to turning force axis B₁. Further, at least distal portion 175 of second element 170, when attached to first element 160, may extend substantially collinear to at least distal portion 165. In other structures, at least distal portion 175 of second element 170, when attached to first element 160, may extend substantially at an angle of 45°-135° to at least distal portion 165. Second force-transmitting axis D₁ would have similar angle to first force-transmitting axis C₁.

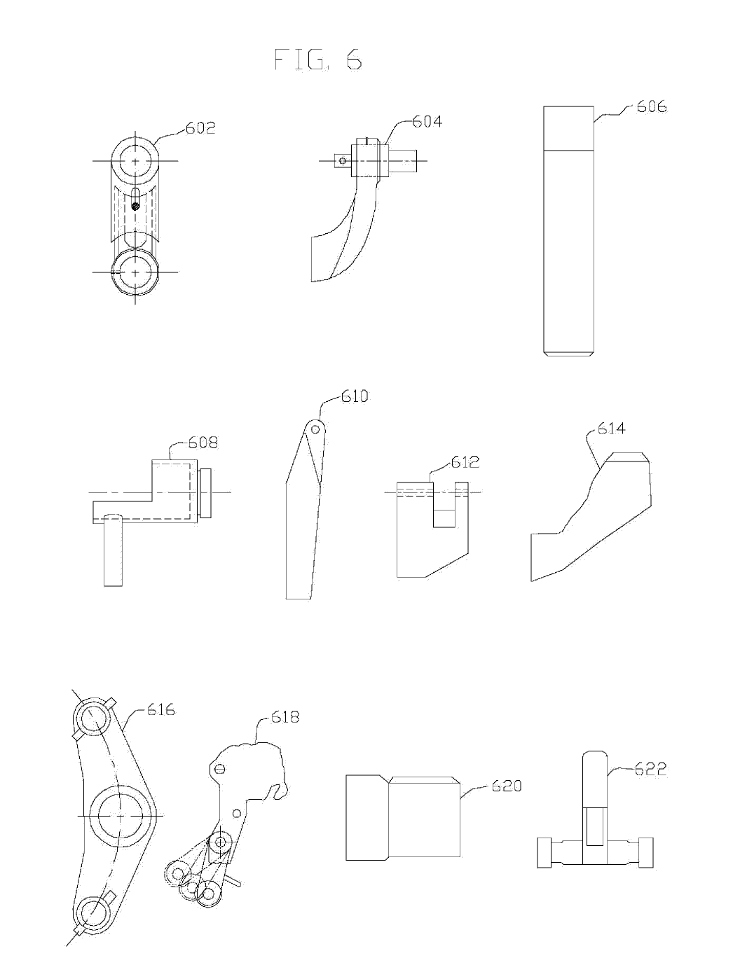

These and other alternative structures of portions of first and second elements 160 and 170 envision the use of commercially available and custom manufactured reaction fixtures with or in replacement of portions of first and/or second elements 160 and 170. FIG. 6 is a display of such commercially available reaction fixtures, including: splined, bore and nut, bore and detent, polygonal, bore and pin, hinged and other connecting means. Examples of some of these commercially available and custom manufactured reaction fixtures include: a dual reaction fixture 602; a standard reaction arm 604; an extended collinear reaction arm 606; a tubular reaction fixture 608; an extended reaction arm 610; a reaction pad 612; a cylinder reaction arm 614; a turbine coupling reaction fixture 616; a three position reaction roller 618; a cylinder reaction foot 620; and an extended reaction roller 622. Other commercially available and custom manufactured reaction fixtures exist and may be adapted to use with portions of first and second elements 160 and 170.

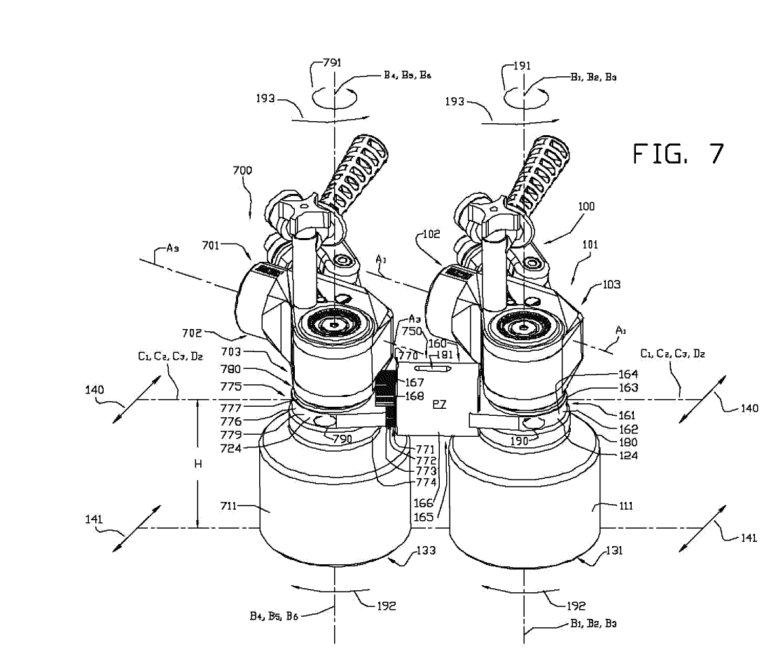

Alternative Embodiments of the Reaction Adaptor. FIG. 7 is a three-dimensional perspective view of tool 100, a first torque power tool 100, and a second torque power tool 700 attached by reaction adaptor 750, an alternative embodiment of reaction adaptor 150. Generally discussion related to FIGS. 1-3 applies to FIG. 7. Tool 100 has a first turning force axis B₁. A second force-transmitting element 770, similar to second element 170, is engageable with and attachable to second torque power tool 700 having a second turning force axis B₄. First tool 100 produces first turning force 190 acting about first turning axis B₁ in one direction 192 during operation. Second tool 700 produces a third turning force 790 acting about second turning force axis B₄ in one direction 192 during operation. First element 160, when attached to first tool 100, receives a second turning force 191 acting in another direction 193 during operation of first tool 100. Second element 770, when attached to second tool 700, receives a fourth turning force 791 acting in another direction 193 during operation of second tool 700. First and third turning forces 190 and 790 turn first and second fasteners 131 and 133. First and third turning forces 190 and 790 are substantially equal to and in opposite directions to second and fourth turning forces 191 and 791. First and second elements 160 and 770, when attached to each other, substantially negate second and fourth turning forces 191 and 791, thereby substantially reducing or negating the usual side load.

In other words, tools 100 and 700 are prepared to turn nuts 131 and 133 about turning force axes B₁ and B₄ with turning forces 190 and 790 in the same one direction 192. During operation, reaction adaptor 750 receives two reaction forces, turning forces 191 and 791, about turning force axes B₁ and B₄ in another direction 193. Turning forces 191 and 791 meet in opposite directions at reaction adaptor 750. The twisting and fastener-bending forces are limited and least destructive when turning forces 191 and 791 are transferred perpendicular to turning force axes B₁ and B₄ in plane 140. Thus the ideal abutment pressure point P₇ for reaction adaptor 750 is perpendicular to turning force axes B₁ and B₄ in plane 140.

As discussed previously, tool 100 includes housing 101 having two housing portions, cylinder portion 102 and driving portion 103. Cylinder-piston means 104 are arranged in cylinder portion 102 and include cylinder 105, piston 106 reciprocatingly movable in cylinder 105 along piston axis A₁, and piston rod 107 connected with piston 106. Known lever-type ratchet mechanism 108 is arranged in driving portion 103, connected to and drivable by cylinder-piston means 104, and includes ratchet 109. Ratchet 109 is turnable about turning force axis B₁ that is perpendicular to piston axis A₁. Ratchet 109 is connected with driving element 110 which receives first turning force 190 acting about a first turning force axis B₁ in one direction 192 during operation of tool 100 (see also FIG. 2). Turning force 190 turns hex socket 111 attached to driving element 110 to turn nut 131.

Reaction support portion 120, connected to driving portion 103 receives second turning force 191 acting about turning force axis B₁ in another direction 193 during operation of tool 100. Reaction support portion 120 is formed of annular polygonal body 121 having the plurality of outer splines 123. Outer splines 123 are positioned circumferentially around annular body 121 and extend radially outwardly from central axis B₂ which is coaxial with first turning force axis B₁.

Referring back to FIG. 1 as it relates to the components of tool 700 not shown in FIG. 7, tool 700 includes a housing 701 having two housing portions, a cylinder portion 702 and a driving portion 703. Cylinder-piston means 704 are arranged in cylinder portion 702 and include a cylinder 705, a piston 706 reciprocatingly movable in cylinder 705 along a piston axis A₃, and a piston rod 707 connected with piston 706. A known lever-type ratchet mechanism 708 is arranged in driving portion 703, connected to and drivable by cylinder-piston means 704, and includes a ratchet 709. Ratchet 709 is turnable about second turning force axis B₄ that is perpendicular to piston axes A₁ and A₃ and parallel to first turning force axis B₁. Ratchet 709 is connected with a driving element 710 which receives third turning force 790 acting about turning force axis B₄ in one direction 192 during operation of tool 700 (see also FIG. 2). Third turning force 790 turns a hex socket 711 attached to driving element 710 to turn nut 133.

A reaction support portion 720, connected to driving portion 703 receives a fourth turning force 791 acting about turning force axis B₄ in another direction 193 during operation of tool 700. Reaction support portion 720 is formed of an annular polygonal body 721 having a plurality of outer splines 723. Outer splines 723 are positioned circumferentially around annular body 721 and extend radially outwardly from a central axis B₅ which is coaxial with second turning force axis B₄.

Reaction adaptor 750 generally includes first force-transmitting element 160, when engaged with tool 100, being rotatable about turning force axis B₁; and a second force-transmitting element 770, when engaged with first element 160, being one of rotatable about, extensible and retractable along, and rotatable about and extensible and retractable along at least distal portion 165. First element 160 includes proximal portion 161 formed of annular polygonal body 162 having plurality of inner splines 163, and distal portion 165 formed of tubular member 166 having internal bore 167 with plurality of inner splines 168. Second element 770 includes proximal portion 771 formed of tubular member 772 having plurality of outer splines 173, and a distal portion 775 formed of an annular polygonal body 776 having a plurality of inner splines 777. As shown in FIG. 7, first element 160, when attached to tool 100, extends substantially perpendicular to and has first force-transmitting axis C₁ substantially perpendicular to turning force axis B₁. Second element 770, when attached to tool 700, extends substantially perpendicular to and has a second force transmitting axis D₂ substantially perpendicular to turning force axis B₂. First element 160, when attached to second element 770, extends substantially collinear to first force-transmitting axis C₁. Likewise, second element 770, when attached to first element 160, extends substantially collinear to second force-transmitting axis D₂.

First element 160 is shown non-rotatably attached to reaction support portion 120 in first position and held in place by locking mechanism 180. First element 160 is engageable and attachable separately, individually, and independently to tool 100 and second element 770. Inner splines 163 are positioned circumferentially around the inside of annular body 162 and extend radially inwardly toward central axis B₃. Annular body 162 is of such inner width and annular body 121 is of such outer width that inner splines 163 mesh with outer splines 123. Annular body 121 and proximal portion 161 include first and second connecting means 124 and 164. Reaction support portion 120 and first element 160 are attachable to each other by attaching first and second connecting means 121 and 164. Axes B₁, B₂, and B₃ are coaxial when first element 160 and reaction support portion 120 arc attached to each other and to tool 100.

Second element 770 is shown non-rotatably attached to first element 160 in a second position and held in place by a locking mechanism 181. Second element 770 is engageable and attachable separately, individually, and independently to first element 160. Inner splines 168 are positioned circumferentially around the inside of internal bore 167 and extend radially inwardly toward a central axis C₂. Outer splines 773 are positioned circumferentially around tubular member 772 and extend radially outwardly from a central axis C₃. Internal bore 167 is of such inner width and tubular member 772 is of such outer width that inner splines 168 mesh with outer splines 773. Internal bore 167 receives tubular member 772 in a telescoping arrangement. Distal portion 165 includes third connecting means 169 which comprises tubular member 166, internal bore 167, and inner splines 168. Proximal portion 771 includes fourth connecting means 774 which comprises tubular member 772 and outer splines 773. First and second elements 160 and 770 are attachable to each other by attaching third and fourth connecting means 169 and 774 which are held in place by locking mechanism 181. Axes B₁, B₂, and B₃ are substantially coaxial and C₁, C₂, C₃ and D₂ are substantially coaxial when tool 100 with reaction support portion 120, first element 160, second element 770 and tool 700 with reaction support portion 720 are attached.

Further, second element 770 is shown non-rotatably attached to reaction support portion 720 in second position and held in place by locking mechanism 780. Second element 770 is engageable and attachable separately, individually, and independently to tool 700. Inner splines 777 are positioned circumferentially around the inside of annular body 776 and extend radially inwardly toward central axis B₆. Annular body 776 is of such inner width and annular body 721 is of such outer width that inner splines 777 mesh with outer splines 723. Annular body 721 and distal portion 775 include fifth and sixth connecting means 724 and 779. Reaction support portion 720 and second element 770 are attachable to each other by attaching fifth and sixth connecting means 724 and 779. Axes B₄, B₅, and B₆ are coaxial when second element 770 and reaction support portion 720 are attached to each other and to tool 700.

In another embodiment of the reaction adaptor, a reaction hub connects four torque power tools, each similar to tool 100. Generally discussion related to FIGS. 1-7 applies to the reaction hub. The reaction hub is formed of four force-transmitting elements, each similar to distal portion 165 of first element 160 and each extending radially outwardly from a base region in four perpendicular directions. Each tool has a force-transmitting element similar to second element 770. Each tool is attached by its element to an element of the reaction hub, similar to FIG. 7. Each tool produces a turning force acting about their respective turning force axis in one direction during operation. Each reaction hub element receives the reaction turning force from their respective tools acting in another opposite direction. The tool turning forces turn fasteners and are substantially equal to and in opposite directions to the tool reaction turning forces. The reaction hub elements and the tool elements, when attached to each other, substantially negate the tool reaction turning forces, thereby substantially reducing or negating the usual side load. In other words, each tool is prepared to turn a nut about its turning force axes with its turning force in the same one direction. During operation, the reaction hub receives four reaction turning forces in the same another direction. The tool turning forces meet their respective reaction turning forces in opposite directions at the reaction hub. The twisting and fastener-bending forces are limited and least destructive when the tool turning forces are transferred perpendicular to their turning force axes in the equivalent to plane 140. Thus the ideal abutment pressure point for each element of the reaction hub is perpendicular to each tool turning force axes in the equivalent to plane 140. The reaction hub and variations and combinations thereof allow for the use of a plurality of tools, a plurality of reaction adaptors, and a plurality of force-transmitting elements to turn a plurality of fasteners at the same time. Note that the reaction hub may include a plurality of force-transmitting elements extending radially outwardly from the base region at an angle of 0°-360° to each other.

Generally discussion related to the method of FIG. 4 applies to FIG. 7. In step 412 of FIG. 4, second element 770 is engaged with first element 160 by bringing proximal portion 771 substantially adjacent to distal portion 165 and substantially aligning axes C₁, C₂, and C₃. Note that second element 770 is attached to tool 700 utilizing steps similar to those described in steps 404-410 of FIG. 4.

Tools 100 and 700 are prepared to turn nuts 131 and 133 about turning force axes B₁ and B₄ with turning forces 190 and 790 in the same one direction 192. In step 414 of FIG. 4, tool 700 with second element 770 attached about turning force axis B₄ is positioned to turn nut 133 by extending and/or retracting second element 770 along distal portion 165. While unlikely to be performed in the present embodiment, second element 770 and thus tool 700, when engaged with first element 160, are rotatable about distal portion 165 because inner splines 168 have not yet been meshed with outer splines 773. Inner splines 165 and outer splines 773 are meshed when internal bore 167 receives tubular member 772 in a telescoping arrangement; and second element 770 is retracted along distal portion 165 to an extension length which corresponds to the proximity of nut 133. In step 416 of FIG. 4, second element 770 is attached to first element 160 in the second position by activating locking mechanism 181. Reaction adaptor 750 is now in reaction force transfer position. In steps not shown in FIG. 4, hex socket 711 is attached to driving element 710, and tool 700 is placed on nut 133.

Note that the order of assembly referenced above related to FIG. 7 may be varied. For example, second element 770 may be engaged with first element 160 prior to second element 770 being engaged with tool 700. In this variation, hex socket 711 is on nut 133 and reaction adaptor 770 is fully assembled and pre-adjusted. Tool 700 is attached to hex socket 711 in an operating position by passing driving element 710 through distal portion 775.

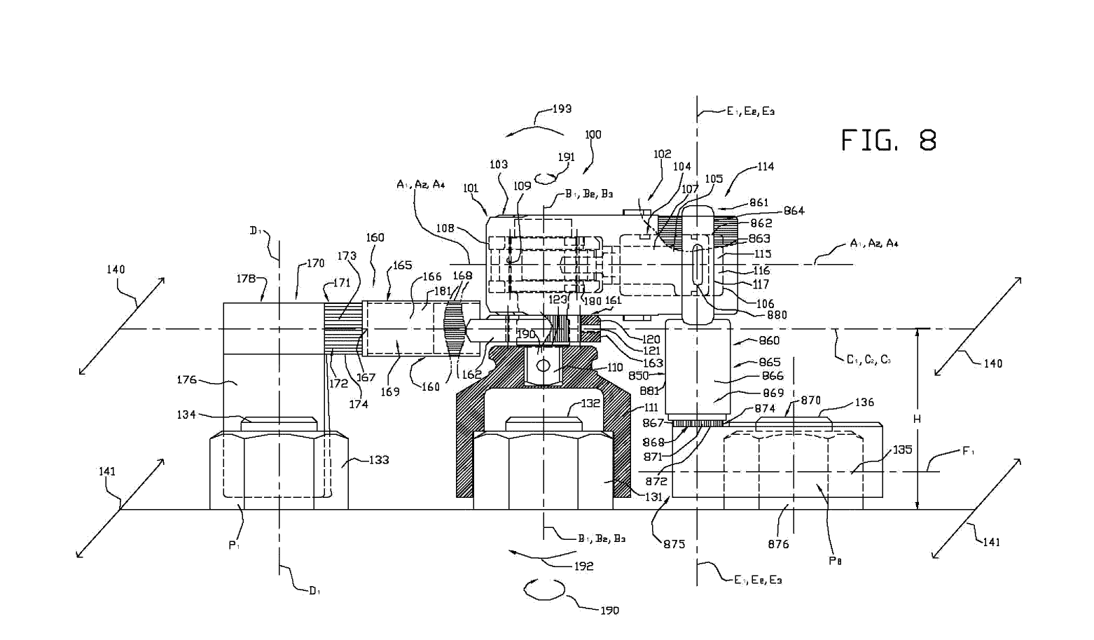

Alternative Embodiments of the Placement and Quantity of the Reaction Adaptor. FIG. 8 shows a side view of tool 100 having reaction adaptor 150, a first reaction adaptor, and a second reaction adaptor 850. Generally discussion related to FIGS. 1-7 applies to FIG. 8. Second reaction adaptor 850, similar to first reaction adaptor 150, has a third force-transmitting element 860, when engaged with tool 100, being rotatable about a piston axis of the tool; and a fourth force-transmitting element 870, when engaged with third element 860, being one of rotatable about, extensible and retractable along, and rotatable about and extensible and retractable along at least a distal portion 865 of third element 860.

A second reaction adaptor 850 generally includes third force-transmitting element 860, when engaged with tool 100, being rotatable about piston axis A₁; and a fourth force-transmitting element 870, when engaged with third element 860, being one of rotatable about, extensible and retractable along, and rotatable about and extensible and retractable along at least a distal portion 865 of first element 860. Third element 860 includes a proximal portion 861 formed of an annular polygonal body 862 having a plurality of inner splines 863, and distal portion 865 formed of a tubular member 866 having an internal bore 867 with a plurality of inner splines 868. Fourth element 870 includes a proximal portion 871 formed of a tubular member 872 having a plurality of outer splines 873, and a distal portion 875 formed of a rectangular body 876. Third element 860, when attached to tool 100, extends substantially perpendicular to and has a third force-transmitting axis E₁ substantially perpendicular to piston axis A₁. Fourth element 870, when attached to third element 860, extends substantially perpendicular to and has a fourth force-transmitting axis F₁ substantially perpendicular to third force-transmitting axis E₁.

Third element 860 is shown non-rotatably attached to reaction support portion 114 in a third position and held in place by a locking mechanism 880. First element 860 is engageable and attachable separately, individually, and independently to tool 100. Inner splines 863 are positioned circumferentially around the inside of annular body 862 and extend radially inwardly toward a central axis A₄. Annular body 862 is of such inner width and annular body 115 is of such outer width that inner splines 863 mesh with outer splines 116. Annular body 115 and proximal portion 861 include seventh and eighth connecting means 117 and 864. Reaction support portion 114 and first element 860 are attachable to each other by attaching seventh and eighth connecting means 117 and 864. Axes A₁, A₂, and A₄ are substantially coaxial when first element 860 and reaction support portion 114 are attached to each other and to tool 100.

Note that reaction support portion 114 has a height such that third element 860, when engaged with tool 100, is also slidable along reaction support portion 114. In this variation, annular body 862 may also have a height such that third element 860 is extensible and retractable along reaction support portion 114.

Fourth element 870 is shown non-rotatably attached to third element 860 in a fourth position and held in place by a locking mechanism 881. Fourth element 870 is engageable and attachable separately, individually, and independently to third element 860. Inner splines 868 are positioned circumferentially around the inside of internal bore 867 and extend radially inwardly toward a central axis E₂. Outer splines 873 are positioned circumferentially around tubular member 872 and extend radially outwardly from a central axis E₃. Internal bore 867 is of such inner width and tubular member 872 is of such outer width that inner splines 868 mesh with outer splines 873. Internal bore 867 receives tubular member 872 in a telescoping arrangement. Distal portion 865 includes ninth connecting means 869 which comprises tubular member 866, internal bore 867, and inner splines 868. Proximal portion 871 includes tenth connecting means 874 which comprises tubular member 872 and outer splines 873. First and second elements 860 and 970 are attachable to each other by attaching third and fourth connecting means 869 and 874 which are held in place by locking mechanism 881. Axes E₁, E₂, and E₃ are substantially coaxial and F₁, F₂, and F₃ are substantially coaxial when second element 870, first element 860 and reaction support portion 814 are attached to each other and to tool 100. Rectangular body 876 of distal portion 875 extends substantially perpendicular to tubular member 872.

As shown in FIG. 8, tool 100 is prepared to turn nut 131 threaded on lug 132 to connect flanges (not shown). Reaction adaptor 150 transfers turning force 191 to nut 133 at abutment pressure point P₁ during operation. Reaction adaptor 850 further transfers turning force 191 to nut 135 at abutment pressure point P₈ during operation. Distal portion 175 extends downward, substantially perpendicular to first element 160. Distal portion 875 extends sideways, substantially perpendicular to third element 860. As turning force 190 turns hex socket 111 on nut 131, rectangular body 176, supported by distal portion 175 bears against abutment pressure point P₁ on the walls of nut 133 and rectangular body 876, supported by distal portion 875 bears against abutment pressure point P₈ on the walls of nut 135. This prevents ratchet 109 from rotating inwardly relative to nut 131. Thus nut 131 is turned by hex socket 111 to a desired torque.

Reaction adaptors 150 and 850 are connected to reaction support portions 120 and 114 and abutted against nuts 133 and 135 on opposite sides of turning force axis B₁. Driving element 110 receives turning force 190 acting in one direction 192 while reaction support portions 114 and 120 receive turning force 191 equal to and acting in another opposite direction 193 during operation of tool 100. Ratchet 109 turns in driving portion 103 in one direction 192 and drives driving element 110 to turn nut 131. Reaction adaptor 850 transfers turning force 191 from reaction support portion 114 to nut 135 and reaction adaptor 150 transfers turning force 191 from reaction support portion 120 to nut 133.

Nut 31 to be turned is located in the center, abutment pressure point P₁ for reaction adaptor 150 is arranged left of center, and abutment pressure point P₈ for reaction adaptor 850 is arranged right of center for reaction adaptor 850. Since action and reaction are equal but opposite, reaction adaptor 150 pushes its abutment area backwards from the center, while reaction adaptor 850 pushes its abutment area forwards from the center (see FIG. 2 in conjunction with FIG. 8). Since both apply an equal force, side loads applied to driving portion 103 balance each other out when both reaction adaptors 150 and 850 are used. Of course, tool 100 may be used with only one of reaction adaptors 150 and 850, as explained above (see FIG. 1-3). Generally discussion related to the method of FIG. 4 applies to FIG. 8. Additional steps, similar to steps 406-416, are performed to account for second reaction adaptor 850 by engaging, with reaction support portion 14, third force-transmitting element 860 being rotatable about piston axis A₁ of tool 100; and engaging, with third element 860, fourth force-transmitting element 870 being one of rotatable about, extensible and retractable along, and rotatable about and extensible and retractable along at least distal portion 865 of third element 860.

In an alternative mode of operation of the placement and quantity of the reaction adaptor, reaction adaptors 150 and 850 may receive turning force 191 to turn nuts 133 and 135. This is achieved by changing the abutment pressure points P₁ and P₈ on the walls of nuts 131 and 135. As ratchet 109 applies turning force 190 to nut 31, reaction adaptors 850 and 150 transfer turning force 191 from reaction support portions 114 and 120 to nuts 133 and 135. Note that only one of reaction support portions 114 and 120 with the corresponding one of reaction adaptors 850 and 150 may be employed depending on applications of tool 100.

Advantageously, as in FIG. 3, reaction adaptors 150 and 850 are adjustable to limit twisting and fastener-bending forces when turning nut 131. Reaction adaptors 150 and 850 may be adjusted, and more specifically elements 160, 170, 860, and 870 may be rotated about, extended and/or retracted along, and rotated about and extended and/or retracted along a plurality of axes, elements and tool parts to achieve ideal abutment pressure points and minimum side loads. Elements 160, 170, 860, and 870 are engageable and attachable separately, individually and independently to a plurality of tools and to each other. The portability of tool 100 is maximized while weight is minimized. When cylindrically smooth connecting means like 569A and 574A are used, reaction adaptors 150 and 850 need not be disassembled to rotate housing 101 about turning force axis B₁. Commercially available reaction fixtures may be used in conjunction with or in replacement of portion of elements 160, 170, 860 and 870 rather than custom reaction fixtures, thereby reducing costs and increasing safety. Operators no longer need several tools at the workstation each having reaction fixtures/adaptors/fixtures oriented differently to abut against viable stationary objects for each application. Nor do operators need to disassemble tool 100, reposition the reaction adaptor, and reassemble tool 100 for each application.

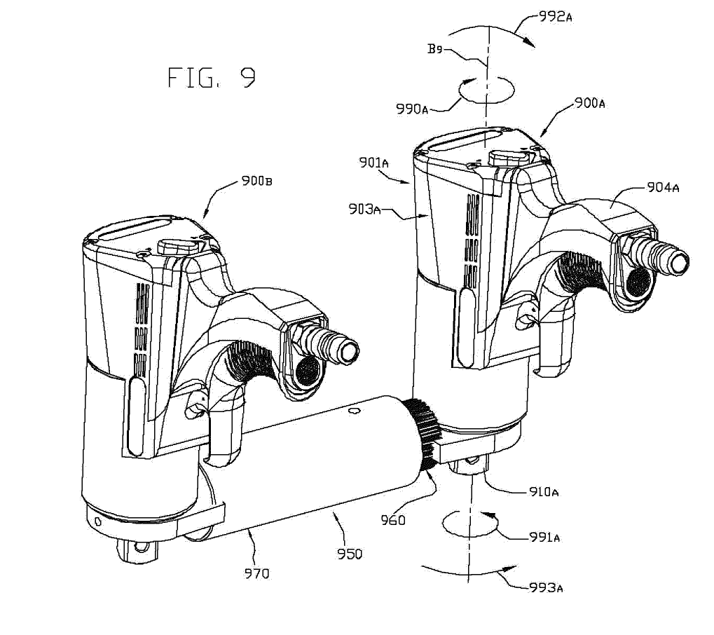

Alternative Types of Tools Which May Utilize the Reaction Adaptors. Torque power tools are known in the art and include those driven pneumatically, electrically, hydraulically, manually, by a torque multiplier, or otherwise powered. FIG. 9 shows a first hand-held torque power wrench 900_{A} and a second hand-held torque power wrench 900_{B} attached by a reaction adaptor 950, similar to that of reaction adaptor 750. First wrench 900_{A} has a housing 901_{A} which accommodates a motor 902_{A} driven pneumatically, electrically, hydraulically, manually, by a torque multiplier, or otherwise powered. Motor 902_{A} produces a turning force 990_{A} acting about a turning force axis B₉ in one direction 992_{A} which turns driving element 910_{A} and provides rotation of a corresponding fastener. First wrench 900_{A} may be provided with torque intensifying means (not shown) for increasing a torque output from motor 902_{A} to driving element 910_{A}. The torque intensifying means may be formed as planetary gears which are located in housing 901_{A}. Generally discussion related to first wrench 900_{A} applies to second wrench 900_{B}. Generally discussion related to reaction adaptor 750 applies to reaction adaptor 950.

Combinations and Variations of All Embodiments and Modes. Combinations and variations of all of embodiments and modes discussed in relation to FIGS. 1-9 may find useful applications. In one combination and variation, for example, a tool similar to tool 900_{A} is attached to a tool similar to tool 100 by a first reaction adaptor similar to reaction adaptors 750 and/or 950 and a second reaction adaptor similar to reaction adaptor 850 is attached to tool 100 at reaction support portion 114. In another combination and variation, for example, a first and a second tool similar to tool 900_{A} and a third and a fourth tool similar to tool 100 are attached to a reaction hub by a first, a second, a third and a fourth reaction adaptor similar to reaction adaptors 750 and/or 950. Further, a fifth and a sixth tool similar to tool 100 are attached to the third and fourth tools by a fifth and a sixth reaction adaptor similar to reaction adaptor 850. In such combinations and variations, a plurality of tool types may be used with a plurality of reaction adaptor and hub types. In additional combination and variations, multiple force-transmitting elements may be utilized by reaction adaptors similar to reaction adaptors 150, 350, 750, 850, 950 and the reaction hub and by tools similar to tools 100 and 900. Indeed, elaborate and complex tool, reaction adaptor and force-transmitting elements, etc. combinations may be utilized as the need arises.

Miscellaneous Information Regarding Reaction Adaptors and Torque Power Tools Having the Adaptors. Reaction adaptors, tools, and other force-transmitting components of the present application may be made from any suitable material such as aluminum, steel, or other metal, metallic alloy, or other alloy including non-metals. Tools of the present application may: load bolt sizes from ½″ to 3½″; have drive sizes from ½″ to 3½″; have hex sizes from ½″ to 8″; have torque output ranges of 100 ft.lbs. to 40,000 ft.lbs; bolt load ranges of 10,000 lbs.-1,500,000 lbs.; and have operating pressures from 1,500 psi to 10,000 psi. Tools of the present application may include Tension, Torque-Tension, and Torque machines, and may include those driven pneumatically, electrically, hydraulically, manually, by a torque multiplier, or otherwise powered. Dimensions of reaction adaptors of the present application may range from 3″×1″×2.5″ to 24″×8″×24″ and weigh from 3 lbs. to 500 lbs. Dimensions of tools of the present application may range from 6″×2″×5″ to 23″×12″×14″ and weigh from 3 lbs. to 500 lbs. Note that reaction adaptors and tools of the present application may substantially diverge, both positively and negatively, from these representative ranges of dimensions and characteristics.

Final Comments. Reaction adaptors for torque power tools pneumatically, electrically, hydraulically and manually driven, tools having the adaptors, and methods of using the same, are disclosed. In one illustrative example, a reaction adaptor includes a first force-transmitting element, when engaged with a tool, being rotatable about a turning force axis of the tool; and a second force-transmitting element, when engaged with the first element, being one of rotatable about, extensible and retractable along, and rotatable about and extensible and retractable along at least a distal portion of the first element. In another illustrative example, a tool for tightening or loosening a fastener includes the reaction adaptor.

A method of using the tool having the reaction adaptor includes the acts of providing the tool; and providing the reaction adaptor. The act of providing the reaction adaptor includes the acts of engaging, with the tool, a first force-transmitting element being rotatable about a turning force axis of the tool; and engaging, with the first element, a second force-transmitting element being one of rotatable about, extensible and retractable along, and rotatable about and extensible and retractable along at least a distal portion of the first element.

Advantageously, the first element is engageable and attachable separately, individually and independently to the tool and the second element is engageable and attachable separately, individually and independently to the first element. Portability of the tool is maximized while weight of the tool is minimized. Commercially available reaction fixtures may be used with or in replacement of portions of first and second elements, rather than custom reaction fixtures, thereby reducing costs and increasing safety. The reaction adaptor is adjustable to minimize twisting and fastener-bending forces so as to avoid the tool from jumping off of the job or from failing. The reaction adaptor, when engaged with the tool, is adjustable to abut against viable and otherwise inaccessible stationary objects at the ideal abutment pressure point. The reaction adaptor, when attached to the tool, transfers the turning force to at the ideal abutment pressure point during operation. Operators no longer need several tools at the workstation each having a reaction fixture oriented differently to abut against viable stationary objects for each application. Nor do operators need to completely disassemble the tool, reposition the reaction adaptor and reassemble tool for each application. Also, the reaction adaptor allows for complete rotation of the tool housing about the turning force axis without changing the abutment point thereby avoiding any circumferential obstructions in a rotation plane of the housing.

It is to be understood that the above is merely a description of preferred embodiments of the present application and that various changes, combinations, alterations, and variations may be made without departing from the true spirit and scope of the invention as set for in the appended claims. The reaction adaptors for torque power tools, tools having the adaptors, and methods of using the same of the present application are described in relation to fasteners and connectors as examples. However, the reaction adaptors for torque power tools, tools having the adaptors, and methods of using the same are viable for use in other residential, commercial, and industrial applications, as well as other devices all together. Few if any of the terms or phrases in the specification and claims have been given any special meaning different from their plain language meaning, and therefore the specification is not to be used to define terms in an unduly narrow sense.

What is claimed is:

1. A reaction adaptor, comprising:
a first force-transmitting element, when engaged with a tool, being rotatable about a turning force axis of the tool; and
a second force-transmitting element, when engaged with the first element, being one of rotatable about, extensible and retractable along, and rotatable about and extensible and retractable along at least a distal portion of the first element.

2. The reaction adaptor of claim 1, further comprising:
a first connecting means at the distal portion of the first element;
a second connecting means at a proximal portion of the second element; and
wherein the second element is engageable with the first element by engaging the first connecting means with the second connecting means.

3. The reaction adaptor of claim 1, further comprising:
wherein at least the distal portion of the first element, when attached to the tool, extends substantially perpendicular to the turning force axis; and
wherein at least a distal portion of the second element, when attached to the first element, extends one of substantially perpendicular to, and substantially collinear with at least the distal portion of the first element.

4. The reaction adaptor of claim 1, further comprising:
wherein at least the distal portion of the first element, when attached to the tool, extends substantially perpendicular to the turning force axis; and
wherein at least a distal portion of the second element, when attached to the first element, extends substantially at an angle of between 45°-315° to at least the distal portion of the first element.

5. The reaction adaptor of claim 1, further comprising:
wherein at least the distal portion of the first element, when attached to the tool, extends substantially at an angle of between 45°-135° to the turning force axis; and
wherein at least a distal portion of the second element, when attached to the first element, extends substantially at an angle of between 45°-315° to at least the distal portion of the first element.

6. The reaction adaptor of claim 1, wherein the adaptor, when engaged with the tool, is adjustable to abut against a stationary object.

7. The reaction adaptor of claim 1, wherein the adaptor, when attached to the tool, transfers a turning force to a stationary object during operation.

8. The reaction adaptor of claim 1, further comprising:
wherein the first element is engageable separately, individually and independently to the tool;
wherein the second element is engageable separately, individually and independently to the first element; and
wherein the adaptor, when engaged with the tool, is adjustable to abut against a stationary object.

9. The reaction adaptor of claim 1, further comprising:
wherein the first element is attachable separately, individually and independently to the tool;
wherein the second element is attachable separately, individually and independently to the first element; and
wherein the adaptor, when attached to the tool, transfers a turning force of the tool to a stationary object during operation.

10. The reaction adaptor of claim 1, further comprising:
wherein the tool produces a first turning force acting about the turning force axis in one direction during operation;
wherein the adaptor, when attached to the tool, receives a second turning force acting in another direction during operation; and
wherein the first and second turning forces are equal to and in opposite directions to each other so that the first turning force turns a fastener to be tightened or loosened while the adaptor transfers the second turning force to a stationary object.

11. The reaction adaptor of claim 1, wherein the tool is one of pneumatically, electrically, hydraulically and manually driven.

12. The reaction adaptor of claim 1, further comprising:
wherein the tool is one of pneumatically, electrically, hydraulically and manually driven and produces a first turning force acting about the turning force axis in one direction during operation;
wherein the adaptor, when attached to the tool, receives a second turning force acting in another direction during operation; and
wherein the first and second turning forces are equal to and in opposite directions to each other so that the first turning force turns a fastener to be tightened or loosened while the adaptor transfers the second turning force to a stationary object.

13. The reaction adaptor of claim 1, further comprising:
the tool, comprising:
a housing having a cylinder portion and a driving portion;
cylinder-piston means arranged in the cylinder portion and movable along a piston axis;
a ratchet mechanism:
arranged in the driving portion;
connected to and drivable by the cylinder-piston means;
having a ratchet turnable about the turning force axis which is perpendicular to the piston axis;
a driving element, receiving from the ratchet, a first turning force acting about the turning force axis in one direction during operation;
wherein the adaptor, when attached to the tool, receives a second turning force acting in another direction during operation; and
wherein the first and second turning forces are equal to and in opposite directions to each other so that the first turning force turns a fastener to be tightened or loosened while the adaptor transfers the second turning force to a stationary object.

14. The reaction adaptor of claim 1, further comprising:
wherein the tool comprises a first tool having a first turning force axis; and
wherein the second element is further engageable with a second tool having a second turning force axis.

15. The reaction adaptor of claim 1, further comprising:
wherein the tool comprises a first tool having a first turning force axis;
wherein the second element is further engageable with a tool having a second turning force axis;
wherein the first tool produces a first turning force acting about the first turning force axis in one direction during operation of the first tool;
wherein the second tool produces a second turning force acting about the second turning force axis in the one direction during operation of the second tool;
wherein the first element, when attached to the first tool, receives a third turning force acting in another direction during operation of the first tool;
wherein the second element, when attached to the second tool, receives a fourth turning force acting in the another direction during operation of the second tool;
wherein the first and second turning forces turn a first and second fastener to be tightened or loosened and are substantially equal to and in opposite directions to the third and fourth turning forces; and
wherein the first and second elements, when attached to each other, substantially negate the third and fourth turning forces.

16. The reaction adaptor of claim 1, further comprising:
wherein the reaction adaptor comprises a first reaction adaptor;
a second reaction adaptor, comprising:
a third force-transmitting element, when engaged with the tool, being rotatable about a piston axis of the tool; and
a fourth force-transmitting element, when engaged with the third element, being one of rotatable about, extensible and retractable along, and rotatable about and extensible and retractable along at least a distal portion of the third element.

17. The reaction adaptor of claim 1, further comprising:
wherein the reaction adaptor comprises a first reaction adaptor;
a second reaction adaptor, comprising:
a third force-transmitting element, when engaged with the tool, being rotatable about a piston axis of the tool; and
a fourth force-transmitting element, when engaged with the third element, being one of rotatable about, extensible and retractable along, and rotatable about and extensible and retractable along at least a distal portion of the third element;
wherein at least the distal portion of the first element, when attached to the tool, extends substantially at an angle of between 45°-135° to the turning force axis;
wherein at least a distal portion of the second element, when attached to the first element, extends substantially at an angle of between 45°-315° to at least the distal portion of the first element;
wherein at least the distal portion of the third element, when attached to the tool, extends substantially at an angle of between 45°-135° to the piston axis; and
wherein at least a distal portion of the fourth element, when attached to the third element, extends substantially at an angle of between 45°-315° to at least the distal portion of the third element.

18. The reaction adaptor of claim 1, wherein the second force-transmitting element further comprises a reaction hub.

19. The reaction adaptor of claim 1, wherein the adaptor includes one of a plurality of commercially available and custom manufactured force-transmitting elements comprising one of a splines, bore and nut, bore and detent, polygonal and bore and pin connecting means.

20. A tool, comprising:
a reaction adaptor, comprising:
a first force-transmitting element, when engaged with the tool, being rotatable about a turning force axis of the tool; and
a second force-transmitting element, when engaged with the first element, being one of rotatable about, extensible and retractable along, and rotatable about and extensible and retractable along at least a distal portion of the first element.

21. The tool of claim 20, further comprising:
a first connecting means at the distal portion of the first element;
a second connecting means at a proximal portion of the second element; and
wherein the second element is engageable with the first element by engaging the first connecting means with the second connecting means.

22. The tool of claim 20, further comprising:
wherein at least the distal portion of the first element, when attached to the tool, extends substantially perpendicular to the turning force axis; and
wherein at least a distal portion of the second element, when attached to the first element, extends one of substantially perpendicular to and substantially collinear to at least the distal portion of the first element.

23. The tool of claim 20, further comprising:
wherein at least the distal portion of the first element, when attached to the tool, extends substantially perpendicular to the turning force axis; and
wherein at least a distal portion of the second element, when attached to the first element, extends substantially at an angle of between 45°-315° to at least the distal portion of the first element.

24. The tool of claim 20, further comprising:
wherein at least the distal portion of the first element, when attached to the tool, extends substantially at an angle of between 45°-135° to the turning force axis; and
wherein at least a distal portion of the second element, when attached to the first element, extends substantially at an angle of between 45°-315° to at least the distal portion of the first element.

25. The tool of claim 20, wherein the adaptor, when engaged with the tool, is adjustable to abut against a stationary object.

26. The tool of claim 20, wherein the adaptor, when attached to the tool, transfers a turning force to a stationary object during operation,

27. The tool of claim 20, further comprising:
wherein the first element is engageable separately, individually and independently to the tool;
wherein the second element is engageable separately, individually and independently to the first element; and
wherein the adaptor, when engaged with the driving portion, is adjustable to abut against a stationary object.

28. The tool of claim 20, further comprising:
wherein the first element is attachable separately, individually and independently to the tool;
wherein the second element is attachable separately, individually and independently to the first element; and
wherein the adaptor, when attached to the driving portion, transfers a turning force of the tool to a stationary object during operation.

29. The tool of claim 20, further comprising:
wherein the tool produces a first turning force acting about the turning force axis in one direction during operation;
wherein the adaptor, when attached to the tool, receives a second turning force acting in another direction during operation; and
wherein the first and second turning forces are equal to and in opposite directions to each other so that the first turning force turns a fastener to be tightened or loosened while the adaptor transfers the second turning force to a stationary object.

30. The tool of claim 20, wherein the tool is one of pneumatically, electrically, hydraulically and manually driven.

31. The tool of claim 20, further comprising:
wherein the tool is one of pneumatically, electrically, hydraulically and manually driven and produces a first turning force acting about the turning force axis in one direction during operation;
wherein the adaptor, when attached to the tool, receives a second turning force acting in another direction during operation; and
wherein the first and second turning forces are equal to and in opposite directions to each other so that the first turning force turns a fastener to be tightened or loosened while the adaptor transfers the second turning force to a stationary object.

32. The tool of claim 20, further comprising:
a housing having a cylinder portion and a driving portion;
cylinder-piston means arranged in the cylinder portion and movable along a piston axis;
a ratchet mechanism:
arranged in the driving portion;
connected to and drivable by the cylinder-piston means;
having a ratchet turnable about the turning force axis which is perpendicular to the piston axis;
a driving element, receiving from the ratchet, a first turning force acting about the turning force axis in one direction during operation;
wherein the adaptor, when attached to the driving portion, receives a second turning force acting in another direction during operation; and
wherein the first and second turning forces are equal to and in opposite directions to each other so that the first turning force turns a fastener to be tightened or loosened while the adaptor transfers the second turning force to a stationary object.

33. The tool of claim 20, further comprising:
wherein the tool comprises a first tool having a first turning force axis; and
wherein the second element is further engageable with a second tool having a second turning force axis.

34. The tool of claim 20, further comprising:
wherein the tool comprises a first tool having a first turning force axis;
wherein the second element is further engageable with a second tool having a second turning force axis;
wherein the first tool produces a first turning force acting about the first turning axis in one direction during operation of the first tool;
wherein the second tool produces a second turning force acting about the second turning force axis in the one direction during operation of the second tool;
wherein the first element, when attached to the first tool, receives a third turning force acting in another direction during operation of the first tool;
wherein the second element, when attached to the second tool, receives a fourth turning force acting in the another direction during operation of the second tool;
wherein the first and second turning forces turn a first and second fastener to be tightened or loosened and are substantially equal to and in opposite directions to the third and fourth turning forces; and
wherein the first and second elements, when attached to each other, substantially negate the third and fourth turning forces.

35. The tool of claim 20, further comprising:
wherein the reaction adaptor comprises a first reaction adaptor;
a second reaction adaptor, comprising:
a third force-transmitting element, when engaged with the tool, being rotatable about a piston axis of the tool; and
a fourth force-transmitting element, when engaged with the third element, being one of rotatable about, extensible and retractable along, and rotatable about and extensible and retractable along at least a distal portion of the third element.

36. The tool of claim 20, further comprising:
wherein the reaction adaptor comprises a first reaction adaptor;
a second reaction adaptor, comprising:
a third force-transmitting element, when engaged with the tool, being rotatable about a piston axis of the tool; and
a fourth force-transmitting element, when engaged with the third element, being one of rotatable about, extensible and retractable along, and rotatable about and extensible and retractable along at least a distal portion of the third element;
wherein at least the distal portion of the first element, when attached to the tool, extends substantially at an angle of between 45°-135° to the turning force axis;
wherein at least a distal portion of the second element, when attached to the first element, extends substantially at an angle of between 45°-315° to at least the distal portion of the first element;
wherein at least the distal portion of the third element, when attached to the tool, extends substantially at an angle of between 45°-135° to the piston axis; and
wherein at least a distal portion of the fourth element, when attached to the third element, extends substantially at an angle of between 45°-315° to at least the distal portion of the third element.

37. The tool of claim 20, wherein the second force-transmitting element further comprises a reaction hub.

38. The tool of claim 20, wherein the adaptor includes one of a plurality of commercially available and custom manufactured force-transmitting elements comprising one of a splines, bore and nut, bore and detent, polygonal and bore and pin connecting means.

39. A method of using a tool, comprising the acts of:
providing the tool;
providing a reaction adaptor, comprising:
engaging, with the tool, a first force-transmitting element being rotatable about a turning force axis of the tool; and
engaging, with the first element, a second force-transmitting element being one of rotatable about, extensible and retractable along, and rotatable about and extensible and retractable along at least a distal portion of the first element.

40. The method of claim 39, further comprising:
wherein the adaptor further comprises:
a first connecting means at the distal portion of the first element;
a second connecting means at a proximal portion of the second element; and
wherein the second element is engageable with the first element by engaging the first connecting means with the second connecting means.

41. The method of claim 39, wherein the act of providing the reaction adaptor further comprises the acts of:
prior to engaging the second element with the first element, attaching the first element to the tool at a first position, the distal portion of which extends substantially at an angle of between 45°-135° to the turning force axis; and
attaching the second element to the first element at a second position, a distal portion of which extends substantially at an angle of between 45°-315° to the distal portion of the first element.

42. The method of claim 39, wherein the act of providing the reaction adaptor further comprises the acts of:
prior to engaging the second element with the first element, rotating the first element about the turning force axis to a first position;
prior to engaging the second element with the first element but subsequent to rotating the first element about the turning force axis, attaching the first element to the tool at the first position;
positioning the second element to abut against a stationary object at a second position by one of rotating about, extending along, retracting along, rotating about and extending along, and rotating about and retracting along at least the distal portion of the first element; and
attaching the second element to the first element at the second position

43. The method of claim 39, wherein the adaptor, when engaged with the tool, is adjustable to abut against a stationary object.

44. The method of claim 39, wherein the adaptor, when attached to the tool, transfers a turning force to a stationary object during operation.

45. The method of claim 39, further comprising:
wherein the first element is engageable separately, individually and independently to the tool;
wherein the second element is engageable separately, individually and independently to the first element; and
wherein the adaptor, when engaged with the tool, is adjustable to abut against a stationary object.

46. The method of claim 39, further comprising:
wherein the first element is attachable separately, individually and independently to the tool;
wherein the second element is attachable separately, individually and independently to the first element; and
wherein the adaptor, when attached to the tool, transfers a turning force of the tool to a stationary object during operation.

47. The method of claim 39, further comprising:
wherein the tool produces a first turning force acting about the turning force axis in one direction during operation;
wherein the adaptor, when attached to the tool, receives a second turning force acting in another direction during operation of the tool; and
wherein the first and second turning forces are equal to and in opposite directions to each other so that the first turning force turns a fastener to be tightened or loosened while the adaptor transfers the second turning force to a stationary object.

48. The method of claim 39, wherein the tool is one of pneumatically, electrically, hydraulically and manually driven.

49. The method of claim 39, further comprising:
wherein the tool is one of pneumatically, electrically, hydraulically and manually driven and produces a first turning force acting about the turning force axis in one direction during operation;
wherein the adaptor, when attached to the tool, receives a second turning force acting in another direction during operation; and
wherein the first and second turning forces are equal to and in opposite directions to each other so that the first turning force turns a fastener to be tightened or loosened while the adaptor transfers the second turning force to a stationary object.

50. The method of claim 39, further comprising:
wherein the step of providing the tool further comprises:
providing a housing having a cylinder portion and a driving portion;
arranging, in the cylinder portion, cylinder-piston means movable along a piston axis;
arranging, in the driving portion, a ratchet mechanism connected to and drivable by the cylinder-piston means;
providing, in the ratchet mechanism, a ratchet turnable about the turning force axis which is perpendicular to the piston axis; and
providing a driving element, connected to the ratchet, which receives a first turning force acting about the turning force axis in one direction during operation;
wherein the adaptor, when attached to the tool, receives a second turning force acting in another direction during operation; and
wherein the first and second turning forces are equal to and in opposite directions to each other so that the first turning force turns a fastener to be tightened or loosened while the adaptor transfers the second turning force to a stationary object.

51. The method of claim 39, further comprising:
wherein the tool comprises a first tool having a first turning force axis; and
engaging, with the second element, a second tool having a second turning force axis.

52. The method of claim 39, further comprising:
wherein the tool comprises a first tool having a first turning force axis; and
engaging, with the second element, a second tool having a second turning force axis;
wherein the first tool produces a first turning force acting about the first turning force axis in one direction during operation of the first tool;
wherein the second tool produces a second turning force acting about the second turning force axis in the one direction during operation of the second tool;
wherein the first element, when attached to the first tool, receives a third turning force acting in another direction during operation of the first tool;
wherein the second element, when attached to the second tool, receives a fourth turning force acting in the another direction during operation of the second tool;
wherein the first and second turning forces turn a first and second fastener to be tightened or loosened and are substantially equal to and in opposite directions to the third and fourth turning forces; and
wherein the first and second elements, when attached to each other, substantially negate the third and fourth turning forces.

53. The method of claim 39, further comprising:
wherein the reaction adaptor comprises a first reaction adaptor;
providing a second reaction adaptor, comprising:
engaging, with the tool, a third force-transmitting element being rotatable about a piston axis of the tool; and
engaging, with the third element, a fourth force-transmitting element being one of rotatable about, extensible and retractable along, and rotatable about and extensible and retractable along at least a distal portion of the third element.

54. The method of claim 39, wherein the second force-transmitting element further comprises a reaction hub.

55. The method of claim 39, wherein the adaptor includes one of a plurality of commercially available and custom manufactured force-transmitting elements comprising one of a splines, bore and nut, bore and detent, polygonal and bore and pin connecting means.
